(19) United States
(12) Patent Application Publication
(10) Pub. No.: US 2007/0033099 A1
(43) Pub. Date: Feb. 8, 2007

(54) GSM/GPRS desktop phone message banner

(75) Inventor: Xiongwei Zhu, Shanghai (CN)

Correspondence Address: PERKINS COIE LLP;PATENT-SEA, P.O. BOX 1247, SEATTLE, WA, 98111-1247, US

(73) Assignee: Spreadtrum Communications Corporation, Sunnyvale, CA (US)

(21) Appl. No.: 11/195,296

(22) Filed: Aug. 2, 2005

(51) Int. Cl. G06Q 30/00

(52) U.S. Cl. 705/14

(57) ABSTRACT

Systems and methods are provided for displaying messages or other information on the display screen of a telephone, preferably a desktop phone. The messages or other information may be pre-loaded into the phone's memory, such as the nonvolatile, or flash, memory of the phone, or they may be received from a messaging service, or downloaded from the Internet, or from files stored in a computer, or from another suitable source. The messages or other information are preferably displayed when the phone is in standby mode, but they may also be displayed while the phone is in use.

### BACKGROUND OF INVENTION

Desktop phones typically include a display screen for displaying information, such as incoming and outgoing phone numbers, the current time and date, caller identification information, and/or any other suitable information. The displayed information is typically provided via the phone's keypad, via an internal calendar stored in the phone's memory, or, in the case of incoming phone numbers and/or caller information, via a caller identification feature. Caller identification features are typically made available by the company that provides service for the phone.

While much of this displayed information is useful, information that is displayed while the phone is in standby mode, such as the time and date, is often readily obtainable from other sources, such as a watch, a computer, or a desktop calendar. It would be advantageous, therefore, for a desktop phone to display a wider range of useful information on the phone's display screen, particularly when the phone is in standby mode.

### SUMMARY OF THE INVENTION

The invention is directed to systems and methods for displaying messages or other information on the display screen of a telephone, preferably a desktop phone. The messages or other information may be pre-loaded into the phone's memory, such as the nonvolatile, or flash, memory of the phone, or they may be received from a messaging service, or downloaded from the Internet, or from files stored in a computer, or from another suitable source. The messages or other information are preferably displayed when the phone is in standby mode, but may also be displayed while the phone is in use.

In one aspect, a method for displaying information on a desktop phone includes sending data from an information source to a storage area in the phone, and detecting when the phone enters a standby mode. The data is displayed in a readable format on a display screen of the phone when the phone enters the standby mode.

In another aspect, the data is displayed by scrolling at least a portion of the data across the display screen.

In another aspect, at least a portion of the data is displayed as a static image on the display screen.

In another aspect, data categories to be displayed are selectable by a user. The data categories may include advertisements, sports scores, weather, news, and/or other suitable data categories.

In another aspect, the information source comprises a messaging service. The messaging service may be an SMS or a USSD service, or another suitable messaging service.

In another aspect, the information source comprises the Internet, or files stored in a personal computer, and/or another suitable source.

In another aspect, a message header comprising a first portion of the data, and a message body comprising a second portion of the data, are displayed. In one aspect, the message header is displayed statically, and the message body is scrolled across the display screen.

In another aspect, a messaging flag in the storage area of the phone is set to enabled, and the displaying step is not performed until the enabled status of the messaging flag is detected.

In another aspect, a method for displaying information on a desktop phone includes connecting the phone to a computer. Message data from the computer is then downloaded into a storage area in the phone. The method further includes detecting when the phone enters a standby mode, and displaying the message data in a readable format on a display screen of the phone when the phone enters the standby mode.

In another aspect, a system for displaying information on a desktop phone includes means for sending data from an information source to a storage means in the phone, means for detecting when the phone enters a standby mode, and means for displaying the data in a readable format on a display means of the phone when the phone enters the standby mode.

Other features and advantages of the invention will appear hereinafter. The features of the invention described above can be used separately or together, or in various combinations of one or more of them. The invention resides as well in sub-combinations of the features described.

### BRIEF DESCRIPTION OF THE DRAWINGS

FIG. 1 is a perspective view of a desktop phone.

FIG. 2 is a flow diagram of a method for displaying messages and/or other information on the display screen of a desktop phone according to one preferred embodiment.

### DETAILED DESCRIPTION OF THE DRAWINGS

The methods and features described herein may be implemented in any telephone, preferably a desktop phone, having a display screen or other display mechanism. While any type of phone may utilize these features, for ease of description, only a desktop phone will be described herein in detail. Any wireless communication links or features described herein may be implemented via any suitable wireless devices, such as via radio or satellite signal transmitters and receivers. Wireless communication is very common in the mobile phone industry, and any suitable wireless communication features utilized in mobile phones may be used in the desktop phones described herein.

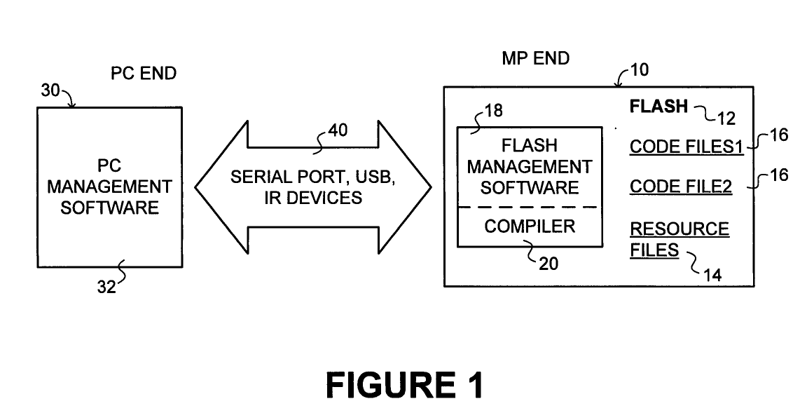

FIG. 1 illustrates a typical desktop phone 10. The desktop phone 10 includes a base unit 12, which includes a plurality of keys and/or buttons 14. The keys or buttons 14 may include number keys, function keys, such as hold, mute, transfer, speed dial, and/or other phone function keys, or any other suitable keys or buttons for triggering phone features or functions. The base unit 12 is preferably connectable to a standard phone jack via a telephone cord 16, or via wireless communication, such as via a radio link, or other suitable communications link.

A handset 18 removably rests on the base unit 12. The handset 18 is connectable to the base unit 12 via a handset cord 20, or the phone 10 may be “cordless,” in which case the handset 18 communicates with the base unit 12 via a radio link or other suitable communications link. The handset 18 may additionally, or alternatively, include one or more of the phone's number, feature, and/or function keys on the top, bottom, and/or side(s) of the handset 18. The handset 18 preferably contains a transmitter and receiver for transmitting and receiving user voices and other sounds.

The desktop phone 10 preferably includes one or more memory storage units contained within the handset 18 and/or the base unit 12. At least one nonvolatile memory unit, such as a flash memory unit, is preferably contained in the desktop phone 10. Flash memory is a type of electrically erasable programmable read-only memory (EEPROM), in which a section of memory cells can typically be erased in a single action, or in a “flash.” Flash memory can be written in blocks, rather than bytes, which makes it relatively easy to update.

A key feature of flash memory is that it retains its data when the device in which it is contained is powered off. Additionally, a flash memory chip, for example, can be electrically erased and reprogrammed without being removed from the circuit board on which it resides. In the desktop phone 10 described herein, nonvolatile memory is preferably embodied in a flash memory card or chip that is insertable into the handset 18 and/or the base 12 of the phone 10. The nonvolatile memory may alternatively be provided in the desktop phone 10 in or on any other suitable medium.

One or more display screens 22, or other suitable display mechanisms, are included on the base 12 and/or the handset 18 of the desktop phone 10. A single display screen 22 is shown on the base 12 for ease of description. The display screen 22 preferably displays outgoing phone numbers as they are dialed, incoming phone numbers and/or caller identification information (if the phone includes caller identification features) as they are received, and/or any other information of interest.

The desktop phone 10 is also preferably in communication with one or more information sources, such as an SMS (short message service) or USSD (unstructured supplemental service data) messaging service. The desktop phone 10 may also be in communication with one or more information networks, such as the Internet, either directly or via connection to a personal computer. Messages or information may also be downloaded or sent to the phone 10 from any other suitable source, such as from files stored in a personal computer. The desktop phone 10 preferably communicates with these services, networks, or other sources via one or more wires and/or cables, or via wireless communication, such as via a radio or satellite link.

The desktop phone 10 preferably receives messages and/or other information, for displaying on the display screen 22, from one or more of these information or messaging services. For example, advertisements, news, sports, weather, and/or any other suitable information may be received from an appropriate source and displayed on the display screen 22 of the desktop phone 10. The messages or other information are preferably stored in a storage area, such as the phone's nonvolatile, or flash, memory, before they are displayed on the display screen 22. Alternatively, the messages and other information may be retrieved and displayed directly from the message or information services.

Certain types of messages or information that do not require real-time updating, such as advertisements, may alternatively be pre-loaded into the phone's memory by the phone's manufacturer or developer, by another programmer, or by a user. In one embodiment, a user may download selected messages, advertisements, or other information from a personal computer, or from another source, into the phone's nonvolatile memory, for later displaying on the display screen 22. Thus, information may be pre-loaded into the phone's memory for display at any time, and/or may be received from messaging and/or other information sources for real-time, or near real-time, display.

The received and/or downloaded messages and other information are preferably displayed on the display screen 22 when the desktop phone 10 is in standby mode, or when the phone 10 is otherwise inactive. When the phone 10 enters standby mode, messages or other information are preferably retrieved from the phone's nonvolatile memory, and displayed on the phone's display screen 22, as described in detail below. In another embodiment, messages and other information may also be displayed when the phone 10 is in use.

In one embodiment, a user is given the option to select which types of messages the user would like displayed on the display screen 22 of the desktop phone 10. For example, a user may select, via keys on the phone 10 and an on-screen menu, or via another suitable mechanism, sports scores and weather as the only types of information to be displayed on the phone's display 22. Alternatively, the user may select, for example, to have sports scores and weather displayed at a higher frequency than other information.

The messages or information displayed on the display screen 22 may be scrolled across the screen 22, or may be displayed statically. Alternatively, portions of the messages or information may be scrolled, while other portions remain static. For example, a message header or identifier may be displayed statically on the display screen 22, while the body of the message is scrolled across the display screen 22.

To illustrate, a message header such as “NFL Scores” may be displayed statically on the screen, while National Football League scores are scrolled beneath (or above, etc.) the message header. After all of the NFL scores have been displayed, a new message header, such as “MLB Scores”, may be retrieved from the phone's nonvolatile memory and statically displayed on the display screen 22. Major League Baseball Scores may then be retrieved from the phone's nonvolatile memory and scrolled across the display screen 22 beneath (or above, etc.) the message header.

The size of the messages or information displayed is limited only by the size of the display screen 22, the available storage area in the phone 10, and/or the capacity of the messaging service or other information source providing the message or information. For example, if an SMS scheme is used, the complete message displayed is limited to a total of 160 bytes. Typically, the message is broken up into one or more of the following: (1) a message class indicator, e.g., a protocol indicating that the message should be displayed in the display screen 22 (approximately 3-5 bytes); (2) a display type indicator, e.g., an indicator that the message should be scrolled or static, etc. (approximately 1 byte); (3) a message length indicator (approximately 1 byte); and (4) the message data itself (approximately 1-155 bytes).

If a USSD scheme is used, on the other hand, larger or longer messages may be displayed on the phone's display screen 22. Thus, an appropriate messaging or information scheme should be chosen to accommodate the size of the messages or information intended to be displayed.

In one embodiment, the user is given the option to turn the messaging feature of the desktop phone 10 on and off, via keys on the phone 10 or via another suitable mechanism. When the user turns the messaging feature on, a flag in the nonvolatile, or flash, memory of the phone is preferably set to enabled, or “true.” When the user turns the messaging feature off, a flag in the nonvolatile, or flash, memory of the phone is preferably set to disabled, or “false.” When the messaging feature is turned off, messages are preferably stored in the nonvolatile memory of the phone 10, but are not displayed on the phone's display screen 22 until the messaging feature is turned on.

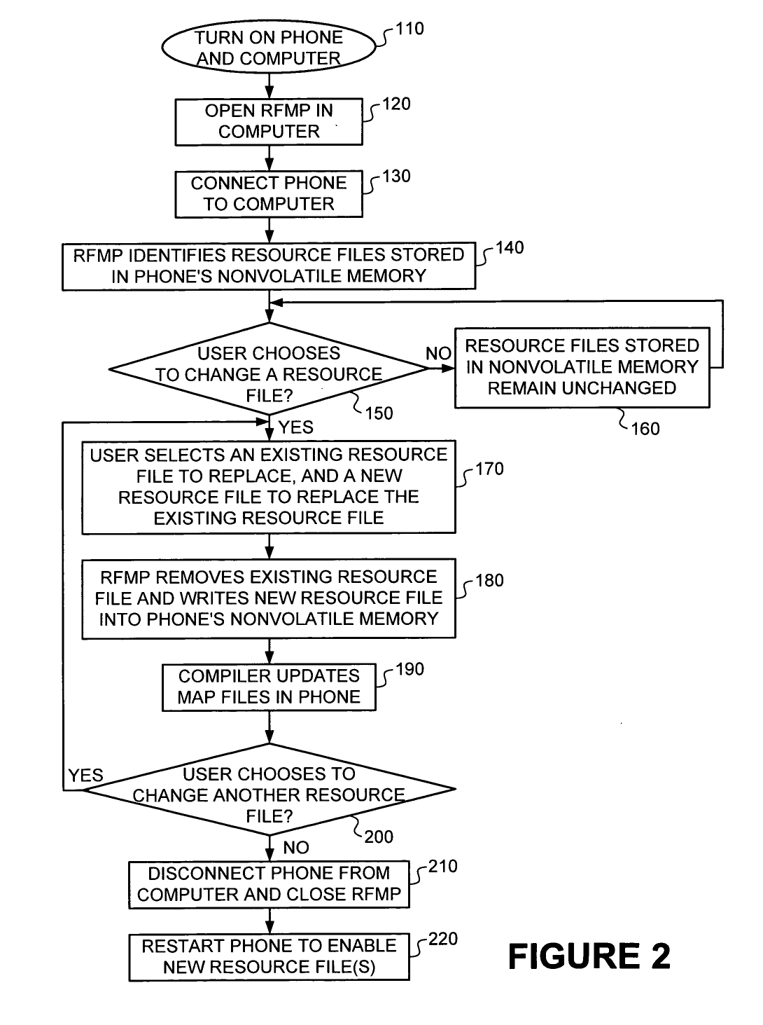

FIG. 2 is a flow diagram illustrating one preferred method for displaying messages and/or other information on the display screen of a desktop phone. At step 100, the phone is turned on or otherwise activated. At step 110, the phone's processor determines whether the phone is currently in, or has entered, standby mode, i.e., whether the phone is not currently in use. If the phone is currently in use, the phone does not display a message, as shown at step 120.

If the phone is in standby mode, or otherwise not in use, the phone's processor checks to see whether the messaging service flag in the phone's nonvolatile memory is set to enabled or “true,” or disabled or “false,” as shown at step 130. If the messaging service flag is set to disabled or “false,” the phone does not display a message (step 120). If the messaging service flag is set to enabled or “true,” the phone's processor retrieves message data or other data stored in the phone's nonvolatile, or flash, memory, as shown at step 140. Alternatively, the processor may retrieve the data directly from the messaging source or other information source.

In one embodiment, the phone's processor determines whether scrolling is enabled or disabled, as shown at step 150. If scrolling is not enabled, the processor displays the message or other data statically on the phone's display screen, in a readable format, as shown at step 160. If scrolling is enabled, the processor scrolls the message across the phone's display screen, in a readable format, as shown at step 170. As described above, the entire message may be scrolled across the display screen, or a portion of the message may be scrolled, depending on the message type and/or settings chosen by a user. For example, a message header may be displayed statically, while the body of the message is scrolled across the display screen.

At step 180, the phone's processor determines whether the phone is still in standby mode. If it is, the process returns to step 130 to determine whether the messaging flag is still enabled. If the messaging flag is still enabled, the process continues from there to display new messages or information. If the phone is no longer in standby mode (e.g., if the phone is in use), the process returns to step 110, to determine when the phone reenters standby mode. The process continues from there.

In one alternative embodiment, messages or information may be displayed on the display screen of the desktop phone while the phone is in use, as well as when the phone is in standby mode. In this embodiment, messages and other information may be continuously displayed on the phone's display screen. The display of messages and other information may be interrupted to allow the display of outgoing or incoming phone numbers, caller identification information, and/or any other suitable information. The user is preferably given the option to have the phone display information continuously, or to display information only when the phone is in standby mode.

While embodiments and applications of the present invention have been shown and described, it will be apparent to one skilled in the art that other modifications are possible without departing from the inventive concepts herein. Importantly, many of the steps detailed above may be performed in a different order than that which is described. The invention, therefore, is not to be restricted except by the following claims and their equivalents.

What is claimed is:

1. A method for displaying information on a desktop phone, comprising the steps of:
sending data from an information source to a storage area in the phone;
detecting when the phone enters a standby mode; and
displaying the data in a readable format on a display screen of the phone when the phone enters the standby mode.

2. The method of claim 1 wherein the displaying step comprises scrolling at least a portion of the data across the display screen.

3. The method of claim 1 where at least a portion of the data is displayed as a static image on the display screen.

4. The method of claim 1 wherein data categories to be displayed are selectable by a user.

5. The method of claim 4 wherein the data categories include at least one of advertisements, sports scores, weather, and news.

6. The method of claim 1 wherein the information source comprises a messaging service.

7. The method of claim 6 wherein the messaging service is one of an SMS and a USSD service.

8. The method of claim 1 wherein the information source comprises at least one of the Internet and files stored in a personal computer.

9. The method of claim 1 wherein the sending step comprises sending the data to a nonvolatile memory of the phone.

10. The method of claim 1 wherein the displaying step comprises:
displaying a message header comprising a first portion of the data; and
displaying a message body comprising a second portion of the data.

11. The method of claim 10 wherein the message header is displayed statically, and the message body is scrolled across the display screen.

12. The method of claim 1 further comprising the step of setting a messaging flag in the storage area of the phone to enabled.

13. The method of claim 12 further comprising the step of detecting that the messaging flag is set to enabled before performing the displaying step.

14. A method for displaying information on a desktop phone, comprising the steps of:
connecting the phone to a computer;
downloading data from the computer into a storage area in the phone;
detecting when the phone enters a standby mode; and
displaying the data in a readable format on a display screen of the phone when the phone enters the standby mode.

15. The method of claim 14 wherein the displaying step comprises scrolling at least a portion of the data across the display screen.

16. The method of claim 14 where at least a portion of the data is displayed as a static image on the display screen.

17. The method of claim 14 wherein the storage area comprises a nonvolatile memory.

18. The method of claim 14 wherein the displaying step comprises:
displaying a message header comprising a first portion of the data; and
displaying a message body comprising a second portion of the data.

19. The method of claim 18 wherein the message header is displayed statically, and the message body is scrolled across the display screen.

20. The method of claim 14 further comprising the step of setting a messaging flag in the storage area of the phone to enabled.

21. The method of claim 20 further comprising the step of detecting that the messaging flag is set to enabled before performing the displaying step.

22. A system for displaying information on a desktop phone, comprising:
means for sending data from an information source to a storage means in the phone;
means for detecting when the phone enters a standby mode; and
means for displaying the data in a readable format on a display means of the phone when the phone enters the standby mode.

23. The system of claim 22 further comprising means for downloading the data from a personal computer into the storage means in the phone.

24. The system of claim 22 further comprising means for setting a messaging flag in the storage means of the phone to enabled or disabled.

25. The system of claim 24 further comprising means for detecting whether the messaging flag is set to enabled or disabled.
